(19) United States
(12) Patent Application Publication
(10) Pub. No.: US 2021/0086170 A1
(43) Pub. Date: Mar. 25, 2021

(54) INDIUM GALLIUM NITRIDE NANOSTRUCTURE SYSTEMS AND USES THEREOF

(71) Applicant: SABIC Global Technologies B.V., Bergen op Zoom (NL)

(72) Inventors: Tayirjan Taylor ISIMJAN, Thuwal (SA); Hicham IDRISS, Thuwal (SA)

(21) Appl. No.: 16/610,196

(22) PCT Filed: May 3, 2018
(86) PCT No.: PCT/IB2018/053079

§ 371 Date: Nov. 1, 2019

Related U.S. Application Data
(60) Provisional application No. 62/500,598, filed on May 3, 2017.

(51) Int. Cl. B01J 27/24; C25B 1/00; C25B 1/04; B01J 31/12; B01J 35/00

(52) U.S. Cl. CPC B01J 27/24; C25B 1/003; B01J 35/004; B01J 31/12; C25B 1/04

(57) ABSTRACT

Photocatalysts for water-splitting to produce hydrogen and oxygen, methods of making and uses thereof are described. The photocatalyst has a catalytic non-oxide metal semiconductor nanostructure attached to a zero valence metal (M^{○}) support. Thecatalyst is capable of catalyzing the production of hydrogen and oxygen from water.

### CROSS REFERENCE TO RELATED APPLICATIONS

This application claims the benefit of priority of U.S. Provisional Patent Application No. 62/500,598 filed May 3, 2017, which is hereby incorporated by reference in its entirety.

### BACKGROUND OF THE INVENTION

### A. Field of the Invention

The invention generally concerns a photocatalyst for water-splitting. In particular, the photocatalyst has a catalytic non-oxide metal semiconductor nanostructure attached to a zero valence metal (M⁰) support. The catalyst is capable of catalyzing the production of hydrogen (H₂) and oxygen (O₂) from water.

### B. Description of Related Art

Photoelectrochemical (PEC) water-splitting systems can combine the harvesting of solar energy with water electrolysis to generate chemical energy in the form of gaseous hydrogen. However, commercialization of current PEC hydrogen-systems as an alternative fuel system suffers from inefficiencies and economic disadvantages due in large part to the deficiencies surrounding the harvesting of solar energy. By way of example, in solar water-splitting, irradiation of a photoelectrode generates photoexcited electrons and holes in a photoelectrode by absorption of photons. The electrons and holes then transfer to the interface of the photoelectrode and the electrolyte to participate in the water reduction and oxidation reactions. The free energy change for the conversion of one molecule of H₂O to hydrogen (H₂) gas and one half oxygen (O₂), as shown below, under standard conditions is 237.2 kJ/mol:

H₂O [symbol] H₂+0.5 O₂

Thus, to accomplish water-splitting, the bandgaps of the semiconductors should be larger than 1.23 eV. To realize efficient solar-to-hydrogen (STH) energy conversion efficiency for water-splitting, the energy gap of the light absorber should be around 2 eV to maximize absorption in the visible range.

Various attempts to address the problems associated with the low STH in a PEC process include using InₓGa₁₋ₓN-based semiconductors as they have adjustable optoelectronic properties, tunable bandgap energies, and n- and p-type doping properties. By way of example, U.S. Published Patent Application No. 20110005590 to Walukiewicz et al., describes InₓGa₁₋ₓN-alloys, where x is 0 to 43 for use in tandem nitride PEC cells.

To enhance the hydrogen gas evolution, maximizing the hole extraction efficiency on the surface of the n-type semiconductor photoanode to improve the water oxidation (the rate limiting factor in PEC water splitting) is crucial. Noble metal oxides (such as IrO₂ and RuO₂) have been used to lower the overpotential for the water oxidation reaction and enhance the hole transport; however, the use of these materials can be limited by the high costs of upscaling to commercial production. To address this, various InₓGa₁₋ₓN-alloys doped with non-noble metal oxides have been described. By way of example, International Application Publication No. WO 2016015134 to Mi et al. describes InₓGa₁₋ₓN-alloys doped with magnesium for use in PEC applications. However, these catalysts can be limited by their stability and the complexity of their interfacial structure with the semiconductor.

Despite various efforts directed at the use of InₓGa₁₋ₓN-based PEC devices, many InₓGa₁₋ₓN-based semiconductor systems still suffer from low STH's (e.g., STH values of approximately 1.8% achieved under 28 Suns in pH-7 solution with the actual STH under 1 Sun at pH=7 is around 0.25%). Even further, many of these devices photodegraded after several hours of use.

### SUMMARY OF THE INVENTION

A solution to the problems associated with semiconductors for use as photocatalysts in PEC systems has been discovered. The discovery is premised on using a supported photocatalyst that includes a catalytic non-oxide metal semiconductor nanostructure attached to a zero valent metal (M⁰) support. By integrating the catalytic non-oxide metal semiconductor nanostructure on the M⁰ support (e.g., the majority of the support is comprised of the zero valent metal. Preferably, the support is substantially all metal or all metal prior to attachment of the nanostructures and/or prior to use), the photogenerated charge carrier transport from the working to the counter electrode can be improved, which in turn improves the carrier extraction efficiency. The photocatalyst can be a monolithic integrated p- or n-type semiconductor and/or can be used as a Z-scheme catalyst (e.g., p and n-type semiconductors). In either instance, the photocatalyst of the present invention can be capable of catalyzing the production of H₂ and/or O₂ from water under photocatalysis conditions. The metal substrate can assist with the migration of the photogenerated electrons to the counter electrode to reduce the hydrogen ions with minimal carrier loss. In addition, the catalytic non-oxide metal semiconductor nanostructure can include an organic ligand that includes linking groups that can inhibit surface passivation and/or also allow coordination with a co-catalyst that promotes hydrogen ion recombination. Such surface functionalization can reduce the density of surface trapping states and improve charge separation that collectively boost the STH efficiency of the system. The systems of the present invention can be PEC systems that can be operated with or without the use of an external bias. In preferred instances, however, the systems can be operated without the use of an external bias.

The photocatalyst of the present invention can be used in a photoanodic PEC two-electrode or three-electrode water-splitting process. In a photoanodic two-electrode PEC water-splitting process, the water oxidation occurs on the semiconductor surface by the diffused holes and the hydrogen reduction is carried out by migrating electrons to the counter electrode. Providing a conductive path for the photogenerated electrons is then indispensable. By integrating small bandgap catalytic non-oxide metal semiconductors on a metal stack substrate, preferably a zero valent metal substrate, the photogenerated charge carrier can be transported from the working electrode to the counter electrode, which provides the advantage of improved carrier extraction efficiency. The photogenerated electrons can then migrate to the counter electrode to reduce the hydrogen ions with minimal carrier loss. Using the catalyst of the present invention, and as exemplified in the Examples, enhanced PEC performance and high gas evolution rates can been realized. By way of example, a 3.5% STH efficiency of unbiased pure water (pH˜7) splitting was achieved using the catalyst of the present invention, which is approximately 14 times higher than the literature reported STH for Group III-nitrides single photoelectrodes at similar experimental conditions (See, Kibria et al., Nature Communications 2015, 6, 779).

In some aspects of the present invention, a supported photocatalyst is described. The supported photocatalyst can include a zero valence metal (M⁰) support and a catalytic non-oxide metal semiconductor nanostructure attached to the support. The M⁰ can include at least one of titanium metal (Ti⁰), molybdenum metal (Mo⁰), tungsten metal (W⁰), tin metal (Sn⁰), alloys, or layers thereof. The non-oxide metal semiconductor nanostructure can include a phosphide (P), nitride (N), or sulfide (S) of at least one metal selected from indium (In), gallium (Ga), cadmium (Cd), zinc (Zn), arsenic (As), nickel (Ni), or combinations thereof, preferably an InGaN nanostructure (e.g., nanorods, nanowires, nanoparticles, tetrapods, tubes, cubes, or mixtures thereof, preferably nanorods, or nanowires). In a preferred embodiment, the metal support includes Mo⁰ and the non-oxide semiconductor nanostructure includes an InGaN nanostructure having the formula of InₓGa₁₋ₓN, where 0.0≤x≤1, preferably 0.3 to 0.7, more preferably 0.4 to 0.5. In some embodiments, the metal support is a Mo⁰—Ti stack. In certain embodiments, a meta (e.g., titanium) nitride interface layer can be between the metal support and the catalytic non-oxide semiconductor. The addition of a TiN layer can inhibit formation of surface oxides during use. Additionally, TiN can be used as a gate metal electrode with a mid-gap work function of approximately 4.25 eV. Thus, the photocatalyst of the present invention having a Mo—Ti support and a TiN interface layer has homogeneous work function that is well-aligned with the bandgaps of catalytic non-oxide metal semiconductor nanostructure (e.g., InGaN or GaN structures), which provides a semiconductor/metal ohmic junction capable of enhancing the carrier transport through the substrate.

The photocatalyst can further include an organic ligand capable of passivating the surface such that formation of surface oxides are reduced or even not formed during use, thus, reducing chemical corrosion and promoting stability of the photocatalyst. The organic ligand can include two or more linking groups. At least one of two linking groups can be attached to the surface of the nanostructure or the surface of the metal support. The photocatalyst can include a first organic ligand attached to the surface of the nanostructure and a second organic ligand attached to the metal support. Multiple ligands can be attached to the nanostructure or the metal support. The organic ligand can have the general formula of:

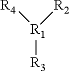

where: R₁ is an aliphatic group, an aromatic group, or a hetero-aromatic group; and R₂, R₃, R₄ are linking groups and are each independently a hydrogen atom, a thiol group, a substituted thiol group, an amino group, a substituted amino group, an hydroxy group, a carbonyl group, a substituted carbonyl group, or a hetero-aromatic group, and at least one or more of R₂, R₃, or R₄ is attached to the surface of the nanostructure or the metal support. In some embodiments, R₁ can be an aliphatic group, R₂ and R₃ can be sulfur atoms that can be attached to the surface of the nanostructure or the metal support, and R₄ can be a hydrogen atom. In some embodiments, the organic ligand is —SCH₂CH₂S— (1,2-ethanedithiol) and at least one of the sulfur atoms is attached to the surface of the nanostructure or the metal support. R₁ is a hetero-aromatic group, and R₃ is a sulfur atom, and R₂ and R₄ are each independently a hetero-aromatic group, and R₃ is attached to the surface of the nanostructure or the metal support. In a preferred instance, the organic ligand is 2,2′:6′,2″-terpyridine-4′-thiol and the sulfur atom of the thiol group is attached to the surface of the nanostructure or the metal support. In some instances, at least one of the two linking groups is complexed with a transition metal. The transition metal can be iridium (Ir), ruthenium (Ru), rhenium (Rh), cobalt (Co), cadmium (Cd), iron (Fe), pallidum (Pd), silver (Ag), or platinum (Pt), or any alloy or combination thereof. In a preferred instance, the transition metal is Ir. Use of a transition metal can lower the overpotential for water oxidation and, thus enhance hole (h⁺) transport. In a preferred instance, the photocatalyst has a Mo/Ti support, a TiN interface layer, and a InₓGa₁₋ₓN-based nanorods, where the nanorod and/or the support has been functionalized with a sulfur-containing organic ligand complexed with iridium.

In another aspect of the invention, processes for making the supported photocatalyst of the present invention are described. A process can include growing a catalytic non-oxide semiconductor nanostructure on a zero valent metal support to form a metal supported catalytic non-oxide semiconductor nanostructure material. The metal supported catalytic non-oxide semiconductor nanostructure material can then be contacted with at least one organic ligand comprising at least one linking group under conditions sufficient to attach the ligand to the catalytic non-oxide semiconductor nanostructure and/or to the metal support.

In another aspect of the invention, methods for producing H₂ are described. A method can include obtaining a composition comprising water and any one of the photocatalysts of the present invention; and subjecting the composition to a light source (e.g., sunlight) for a sufficient period of time to produce H₂ from the water. The solar-to-hydrogen (STH) energy conversion efficiency value can be at least 3.0%, preferably 3.0% to 4.0%, or more preferably about 3.5%.

In yet another aspect of the invention, systems for photocatalytically splitting-water are described. A system can include a reactor having an inlet for feeding water or an aqueous solution to a reaction chamber, the reaction chamber comprising a supported semiconductor catalyst of the present invention. A H₂(g) product outlet can also be incorporated into the system to remove produced H₂ from the reaction chamber. Similarly, the system can also include an O₂(g) product outlet to remove produced O₂ from the reaction chamber. The system can also include a light source configured to provide light to the supported semiconductor catalyst.

In one aspect, 20 embodiments of the present invention are described. Embodiment 1 is supported photocatalyst comprising: (a) a support comprising a metal having a zero valence (M⁰); and (b) a catalytic non-oxide metal semiconductor nanostructure attached to the support. Embodiment 2 is the supported photocatalyst of embodiment 1, wherein M⁰ comprises at least one of molybdenum metal (Mo⁰), titanium metal (Ti⁰), tungsten metal (W⁰), tin metal (Sn⁰), alloys, or layers thereof. Embodiment 3 is the supported photocatalyst of embodiment 2, wherein M⁰ is a Mo⁰—Ti⁰ stack. Embodiment 4 is the supported photocatalyst of any one of embodiments 1 to 3, further comprising a titanium nitride layer positioned between the metal support and the catalytic non-oxide semiconductor. Embodiment 5 is the supported photocatalyst of any one of embodiments 1 to 4, wherein the non-oxide metal semiconductor nanostructure comprises a phosphide (P), nitride (N), or sulfide (S) of at least one metal selected from indium (In), gallium (Ga), cadmium (Cd), zinc (Zn), arsenic (As), nickel (Ni), or combinations thereof, preferably an InGaN nanostructure. Embodiment 6 is the supported photocatalyst of embodiment 5, wherein the metal support comprises Mo⁰ and the non-oxide semiconductor nanostructure is an InGaN nanostructure having the formula of InₓGa₁₋ₓN, where 0.0≤x≤1, preferably 0.3 to 0.7, more preferably 0.40 to 0.50. Embodiment 7 is the supported photocatalyst of any one of embodiments 1 to 6, wherein the photocatalyst further comprises an organic ligand comprising two or more linking groups, wherein at least one of two linking groups is attached to the surface of the nanostructure or the surface of the metal support. Embodiment 8 is the supported photocatalyst of embodiment 7, further comprising a second organic ligand, wherein the first organic ligand is attached to the surface of the nanostructure and the second organic ligand is attached to the metal support. Embodiment 9 is the supported photocatalyst of any one of embodiments 7 to 8, wherein the organic ligand has the general structure of:

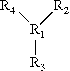

where: R₁ is an aliphatic group, an aromatic group, or a hetero-aromatic group; and R₂, R₃, R₄ are linking groups and are each independently a hydrogen atom, a thiol group, a substituted thiol group, an amino group, a substituted amino group, an hydroxy group, a carbonyl group, a substituted carbonyl group, or a hetero-aromatic group, and at least one or more of R₂, R₃, or R₄ is attached to the surface of the nanostructure or the metal support. Embodiment 10 is the supported photocatalyst of embodiment 9, wherein R₁ is an aliphatic group, R₂ and R₃ are sulfur atoms, and R₄ is a hydrogen atom and R₂ and/or R₃ are attached to the surface of the nanostructure or the metal support. Embodiment 11 is the supported photocatalyst of any one of embodiments 9 to 10, wherein the organic ligand has a formula of —SCH₂CH₂S—, and at least one of the sulfur atoms is attached to the surface of the nanostructure or the metal support. Embodiment 12 is the supported photocatalyst of embodiment 11, wherein R₁ is a hetero-aromatic group, and R₃ is a sulfur atom, and R₂ and R₄ are each independently a hetero-aromatic group and R₃ is attached to the surface of the nanostructure or the metal support. Embodiment 13 is the supported photocatalyst of embodiment 12, wherein the organic ligand has the formula of:

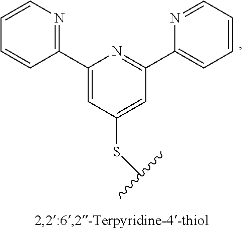 [SMILES: *Sc1cc(-c2ccccn2)nc(-c2ccccn2)c1]

and the sulfur atom is attached to the surface of the nanostructure or the metal support. Embodiment 14 is the supported photocatalyst of any one of embodiments 7 to 13, wherein at least one of the two linking groups is complexed with a transition metal. Embodiment 15 is the supported photocatalyst of embodiment 14, wherein the transition metal is iridium (Ir), ruthenium (Ru), rhenium (Rh), cobalt (Co), cadmium (Cd), iron (Fe), pallidum (Pd), silver (Ag), platinum (Pt), preferably Ir. Embodiment 16 is the supported photocatalyst of any one of embodiments 1 to 15, wherein the catalyst is a monolithic integrated p-type semiconductor. Embodiment 17 is the supported photocatalyst of any one of embodiments 1 to 16, wherein the catalyst is a Z-scheme catalyst and capable of catalyzing the production of H₂ and O₂ from water under photocatalysis conditions. Embodiment 18 is a process for making the supported photocatalyst of any one of embodiments 1 to 17, the process comprising: (a) growing a catalytic non-oxide semiconductor nanostructure on a zero valent metal support to form a metal supported catalytic non-oxide semiconductor nanostructure material; and (b) contacting the metal supported catalytic non-oxide semiconductor nanostructure material with at least one organic ligand comprising at least one linking group under conditions sufficient to attach the ligand to the catalytic non-oxide semiconductor nanostructure and/or the metal support. Embodiment 19 is a method for producing hydrogen (H₂) from water, the method comprising: (a) obtaining a composition comprising water and any one of the photocatalysts of embodiments 1 to 17; and (b) subjecting the composition to a light source, preferably sunlight, for a sufficient period of time to produce H₂ from the water. Embodiment 20 is the method of embodiment 19, wherein the solar-to-hydrogen (STH) energy conversion efficiency value is at least 3.0%, preferably 3.0% to 4.0%, or more preferably about 3.5%.

The following includes definitions of various terms and phrases used throughout this specification.

The phrase “attached” is defined to include a chemical bond, which includes a covalent bond, a hydrogen bond, Van der Walls interaction, an ionic bond, a metal-metal bond, or a metal-element (e.g., M-S, M-P, M-N) bond.

The phrase “aliphatic group” refers to an acyclic or cyclic, saturated or unsaturated hydrocarbon group, excluding aromatic compounds. A linear aliphatic group does not include tertiary or quaternary carbons. A branched aliphatic group includes at least one tertiary and/or quaternary carbon. A cyclic aliphatic group is includes at least one ring in its structure. Polycyclic aliphatic groups may include fused, e.g., decalin, and/or spiro, e.g., spiro[5.5]undecane, polycyclic groups. Aliphatic group substituents can include a halogen, a hydroxyl, an alkyoxy, a haloalkyl, a haloalkoxy, a carbonyl, an amine, an amide, a nitrile, an acyl, a thiol, and a thioether group. An aliphatic group as used herein can be referred to as an alkyl group.

A “carbonyl” refers to a group having a carbon oxygen double bond (i.e, C═O). Non-limiting examples of carbonyl groups are ketones, aldehydes, esters, and carboxylic acids.

The phrase “aromatic group” refers to a substituted or unsubstituted, mono- or polycyclic hydrocarbon with alternating single and double bonds within each ring structure. Aromatic group substituents can include an alkyl, a halogen, a hydroxyl, an alkyoxy, a haloalkyl, a haloalkoxy, a carbonyl an amine, an amide, a nitrile, an acyl, a thiol, and a thioether group.

The phrase “hetero-aromatic group” refers to a mono-or polycyclic hydrocarbon with alternating single and double bonds within each ring structure, and at least one atom within at least one ring is not carbon. Hetero-aromatic group substituents can include an alkyl, a halogen, a hydroxyl, an alkyoxy, a haloalkyl, a haloalkoxy, a carbonyl, an amine, an amide, a nitrile, an acyl, a thiol, and a thioether group.

The terms “nanostructure” or “nanomaterial” refer to an object or material in which at least one dimension of the object or material is equal to or less than 1000 nm (e.g., one dimension is 1 to 1000 nm in size). In a particular aspect, the nanostructure includes at least two dimensions that are equal to or less than 1000 nm (e.g., a first dimension is 1 to 1000 nm in size and a second dimension is 1 to 1000 nm in size). In another aspect, the nanostructure includes three dimensions that are equal to or less than 100,000 nm (e.g., a first dimension is 1 to 1000 nm in size, a second dimension is 1 to 1000 nm in size, and a third dimension is 1 to 1000 nm in size). The shape of the nanostructure can be of a wire, a particle (e.g., having a substantially spherical shape), a rod, a tetrapod, a hyper-branched structure, a tube, a cube, or mixtures thereof. “Nanoparticles” include particles having an average diameter size of 1 to 1000 nanometers.

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The terms “wt. %”, “vol. %”, or “mol. %” refers to a weight, volume, or molar percentage of a component, respectively, based on the total weight, the total volume of material, or total moles, that includes the component. In a non-limiting example, 10 grams of component in 100 grams of the material is 10 wt. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The photocatalysts of the present invention can “comprise,” “consist essentially of,” or “consist of” particular ingredients, components, compositions, etc. disclosed throughout the specification. With respect to the transitional phase “consisting essentially of,” in one non-limiting aspect, a basic and novel characteristic of the photocatalysts of the present invention are their abilities to catalyze photocatalytic water-splitting to produce H₂ and O₂.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings.

FIGS. 1A-1C depict schematics of the photocatalyst of the present invention with a zero valent metal support.

FIG. 2A-2C depict schematics of the photocatalyst of the present invention having organic ligands and metal co-catalyst on a zero valent metal support.

FIG. 3 is a flow chart of a method to prepare the photocatalyst of the present invention is depicted.

FIG. 4 is a schematic of a three-electrode photoelectrochemical system of the present invention for total water-splitting.

FIG. 5 is a schematic of a two-electrode photoelectrochemical system of the present invention for total water-splitting.

FIGS. 6A-D are schematics of the n-type (FIG. 6A) and p-type (FIG. 6C) photocatalyst water-splitting process and the n-type electron-hole equilibrium diagram (FIG. 6B) and the p-type electron-hole equilibrium diagram (FIG. 6D).

FIGS. 7A-7C are schematics of Z-scheme type systems using the photocatalysts of the present invention (FIGS. 7A and 7B) and an electron-hole equilibrium diagram (FIG. 7C).

FIGS. 8A-8I show the morphology and microstructure of the In_{0.33}Ga_{0.67}N-based nanorods of the present invention supported on the Mo substrate.

FIGS. 9A-D depicts atomic-scale surface features before and after EDT/Ir functionalization.

FIGS. 10A-D depict XPS Ga2p, In3d, Ga3s, S2p, and Ir4f of the surface components of the In_{0.33}Ga_{0.67}N-based NRs treated with EDT and Ir co-catalyst.

FIGS. 11A-11D show the PEC performance of In_{0.33}Ga_{0.67}N-based NRs and EDT/Ir functionalized In_{0.33}Ga_{0.67}N-based NRs of the present invention.

FIGS. 12A and 12B show hydrogen and oxygen evolution measured at zero bias and under 1 sun (AM1.5G). FIG. 12A shows the as-grown sample. FIG. 12B shows after EDT/Ir functionalization.

FIGS. 13A-D depict morphology and microstructure of In_{0.33}Ga_{0.67}N-based NRs after a PEC water-splitting experiment.

While the invention is susceptible to various modifications and alternative forms, specific embodiments thereof are shown by way of example in the drawings. The drawings may not be to scale.

### DETAILED DESCRIPTION OF THE INVENTION

A discovery has been made that addresses at least some of the problems associated with photocatalytic water-splitting to produce H₂(g) and O₂(g). The discovery is premised on a photocatalyst that includes a plurality of catalytic non-oxide metal semiconductor nanostructures attached to a layered metal-containing support (e.g., a M⁰ or M-nitride support). The photocatalyst of the present invention as described and exemplified in the Examples section has increased STH as compared to known photocatalyst under the same conditions. The photocatalyst of the present invention can be used without an electrical bias.

These and other non-limiting aspects of the present invention are discussed in further detail in the following sections with reference to the figures.

### A. Photocatalyst

### 1. Catalytic Non-Oxide Metal Semiconductor Nanostructures and M⁰ Support

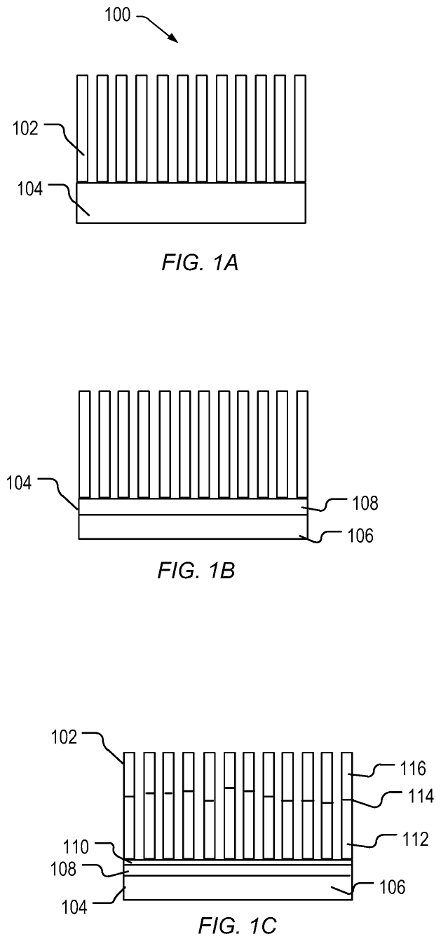

The photocatalyst of the present invention can have catalytic non-metal oxide semiconductor nanostructures attached to the metal support (zero valence metal, metal alloys, or metal stacks). FIGS. 1A, 1B and 1C depict non-limiting schematics of the photocatalyst having a M⁰ support and a catalytic non-metal oxide semiconductor nanostructure attached thereto. Referring to FIG. 1A, photocatalyst 100 includes catalytic non-metal oxide semiconductor nanostructure 102 attached to M⁰support 104. M⁰ can be titanium metal (Ti⁰), molybdenum metal (Mo⁰), tungsten metal (W⁰), tin metal (Sn⁰), alloys, or layers thereof.

FIG. 1B depicts M⁰ support 104 as a stack of layers. Layering the metal support can provide conductivity between support 104 and the catalytic semiconductor 102 and/or decrease hole/electron recombination. As shown, the stack can include first zero valent metal layer 106 and second zero valent metal layer 108. In some embodiments, the stack is made of two, three, four, or five or more layers. First zero valent metal layer 106 can have a dimension of 0.5×0.5×0.25 to 2×2×1 or about 1×1×0.05 cm³. Second zero valent layer 108 can have a thickness of 100 to 1000 nm, or 200 to 800 nm, 300 to 700 nm, 400 to 600 nm, or about 500 nm or any value or range there between. In some embodiments, the first zero valent metal layer is Mo⁰ with a Ti layer (second zero valent metal layer) on at least one surface of the Mo⁰ layer. As shown, the Ti⁰ layer is on the surface of the Mo⁰ layer. The Ti⁰ layer can coat one or more surfaces of the Mo⁰ layer. The support can have at least 50 wt. % zero valent metal, at least 80 wt. % zero valent metal, at least 90 wt. % zero valent metal, at least 95 wt. % zero valent metal or at least 99 wt. % zero valent metal. In some embodiments, the support can include 5 wt. % to 15 wt. %, 8 wt. % to 12 wt. % or 5, 5, 7, 8, 9, 10, 11, 12, 13, 14, 15 wt. % or any range or value there between of Mo and 85 wt. % to 95 wt. %, 87 wt. % to 93 wt. % or 85, 86, 87, 88, 89, 90, 91, 92, 93, 94, 95 wt. % Ti. In one instance, the support includes about 10 wt. % Mo and about 90 wt. % Ti.

In some embodiments, the photocatalyst can include metal nitride interface layer 110 as shown in FIG. 1C. During attachment of nanostructures 102, metal nitride interface layer 110 can be formed. In some embodiments, metal nitride interface layer 110 is not present. In some embodiments, the photocatalyst can include first zero valent metal layer 106 and metal nitride interface layer 110, or first zero valent metal layer 106, second zero valent metal 108 and the metal nitride interface layer. Metal nitride interface layer can have a thickness of 0.1 to 50 nm, or 1 to 40 nm, 2 to 20 nm, 5 to 10 nm, or about 8.5 nm or any value or range there between. In some embodiments, the first zero valent metal layer is Mo⁰ with a Ti layer (second zero valent metal layer) on at least one surface of the Mo⁰ layer. As shown, the Ti⁰ layer is on the surface of the Mo⁰ layer. The Ti⁰ layer can coat one or more surfaces of the Mo⁰ layer. The metal nitride layer can be a TiN layer that is between the nanostructure and the metal support 104.

The nanostructures can be non-oxide metal semiconductors. Non-limiting examples of non-oxide nanostructures include metal pnictogens (e.g., metal phosphides or metal nitrides), or metal chalcogens (e.g., metal sulfides). Non-limiting examples of semiconductor metals include indium (In), gallium (Ga), cadmium (Cd), zinc (Zn), arsenic (As), nickel (Ni), or combinations thereof. Non-limiting examples of metal phosphides include InP, GaP, CdP, ZnP, AsP, and NiP. Non-limiting examples of metal sulfides include InS, GaS, CdS, ZnS, As2S3, and NiS or combinations thereof. Non-limiting examples of metal nitrides include InN, GaN, CdN, ZnN, As₂N₃, GaAsN, Ni₃N₂, and NiN, or combinations thereof. In a preferred embodiment, the nanostructure includes a InGaN nanostructure layer having the formula of InₓGa₁₋ₓN, where 0.0≤x≤1, preferably 0.3 to 0.7, or 0.3, 0.4, 0.5, 0.6, 0.7, or any range or value there between with 0.4 to 0.5 being preferred. Nanostructures 102 can be nanorods, nanowires, nanoparticles, tetrapods, tubes, cubes, or mixtures thereof, with nanorods being preferred. In one aspect, the nanorods are InₓGa₁₋ₓN-based one-dimensional (1D) nanostructures. As shown, nanostructures 102 are elongated or rod-like in structure. In some embodiments, the portion of the nanostructure attached to support 104 can have a different dimension (e.g., larger) than the portion opposite the attached portion. For example, the nanorods can be cone shaped or wires.

In some embodiments, the non-oxide metal semiconductor nanostructure can be a single composition or include one or more layers (e.g, a GaN layer and an InGaN layer). The layers can include layers of different non-oxide metals and/or a dopant layer. Non-limiting examples of dopants include aluminum (Al) or silicon (Si). A dopant layer can be used to mitigate electron overflow during the PEC process and suppress any associated leakage current. In some embodiments, silicon (Si) can be included in one or all the layers. Doping with Si can improve the conductivity and increase the carrier concentration, while forming n-type semiconductors. The molar concentration of the dopant in the layer can be 5 mol. % to 30 mol. %, or 10 mol. % to 25 mol. % or about 20 mol. %. The dopant layer can have the formula AₓGa₁₋ₓN, where A is Al or Si and x is 5 to 30, or 5, 10, 15, 20, 25, 30 or any range or value there between. In one particular aspect, the dopant layer is Al₂₀Ga₈₀N and is between a n-GaN layer and a n-InₓGa₁₋ₓN layer.

FIG. 1C is a schematic of the photocatalyst 100 having layered nanostructures. As shown in FIG. 1C, nanostructure 102 includes non-metal oxide semiconductor layer 112, metal dopant layer 114, and a second non-metal oxide semiconductor layer 116. It should be understood that nanostructure 102 can include more than one dopant layer (e.g., Al-non-oxide metal, AlGaN layer, or the like) or more than one non-oxide metal layer. In other embodiments, dopant layer 114 is not included. Non-metal oxide semiconductor layer 112 (e.g., GaN layer) can be have a thickness of 100 to 150 nm, 110 to 140 nm, 120 to 130 nm, or about 120 nm, or any range or value there between. Dopant layer 114 can have a thickness of 0.5 to 5 nm, 1 to 4 nm, 2 to 3 nm, or 0.5, 1, 1.5, 2, 2.5, 3, 3.5, 4, 4.5, or 5 nm, or any value or range there between. In one embodiment, the dopant layer is about 2.3 nm thick. Non-oxide metal semiconductor layer 116 (e.g., InGaN layer) can have a thickness of 50 to 100 nm, 60 to 90 nm, 70 to 80 nm, or about 84 nm, or any range or value there between. In some embodiments, a fourth non-oxide metal layer can be present between dopant layer and non-oxide metal semiconductor layer 116. The fourth layer (e.g., GaN layer) can have a thickness of 40 to 60 nm, or 40, 45, 50, 55, 60 nm or any range or value there between. One non-limiting examples of layered nanostructures includes a first n-GaN layer connected to the surface of support 104, a n-AlGaN layer attached to the surface of the first n-GaN layer, a second GaN layer attached to the opposite surface of the n-AlGaN layer, and a top InGaN layer connected to the opposite surface of the second GaN layer. Another non-limiting example of layered nanostructures includes a first n-GaN layer connected to the surface of support 104, a n-AlGaN layer attached to the surface of the first n-GaN layer, and a top InGaN layer connected to the opposite surface of the n-AlGaN layer. The first GaN layer can be attached to a metal nitride (e.g., TiN) interface layer that is formed during growth of the nanostructure on the support. In one embodiment, the metal support nanostructure includes a Mo metal substrate, a Ti layer, a TiN layer, an n-GaN layer, a n-Al—GaN layer, and a n-InGaN layer. In another embodiment, the metal support nanostructure includes a Mo metal substrate, a Ti layer, a TiN layer, a first n-GaN layer, a n-Al—GaN layer, a second n-GaN layer, and a n-InGaN layer. In these structures, the n-InGaN layer and Mo metal support are at opposite ends of the overall structure.

### 2. Ligands and Co-Catalysts

Photocatalyst 200 can include one or more ligands that are attached to the surface of the non-oxide metal semiconductor photocatalyst 100. In one instance, the ligands are covalently bonded to the metal surface. The ligand can include at least two linker groups where one linker group can passivate the surface of non-oxide metal bonds (e.g., Ga/In dangling bonds) by filling them with atoms that form covalent bonds with the metal (e.g., Ga and/or In) and simultaneously act as a ligand for attaching metal ion co-catalysts. Surface treatment of the nanostructure can inhibit parasitic light absorption, surface charge trapping and/or reduce the formation of surface oxides that are the source of chemical corrosion and instability, and, thus, providing the advantages of 1) optical quality, 2) catalyst longevity, and/or 3) reduced carrier (e.g., electron and/or hole) loss. For example, surface treating the nanostructure with a short-chain sulfur-containing compound (e.g., 1,2-dithiol) can terminate the surface of non-oxide metal bonds (e.g., Ga/In dangling bonds) by filling the surface with S-atoms that form covalent bonds with the metal (e.g., Ga and/or In) which passivates the nanostructure. Together with the ligand passivation, attachment of a metal co-catalyst (e.g., a catalytic transition metal) can effectively suppress charge recombination, which can alleviate the effects of Fermi level pinning, lower the reaction overpotential, and enhance heterogeneous reaction kinetics across the semiconductor/electrolyte interface.

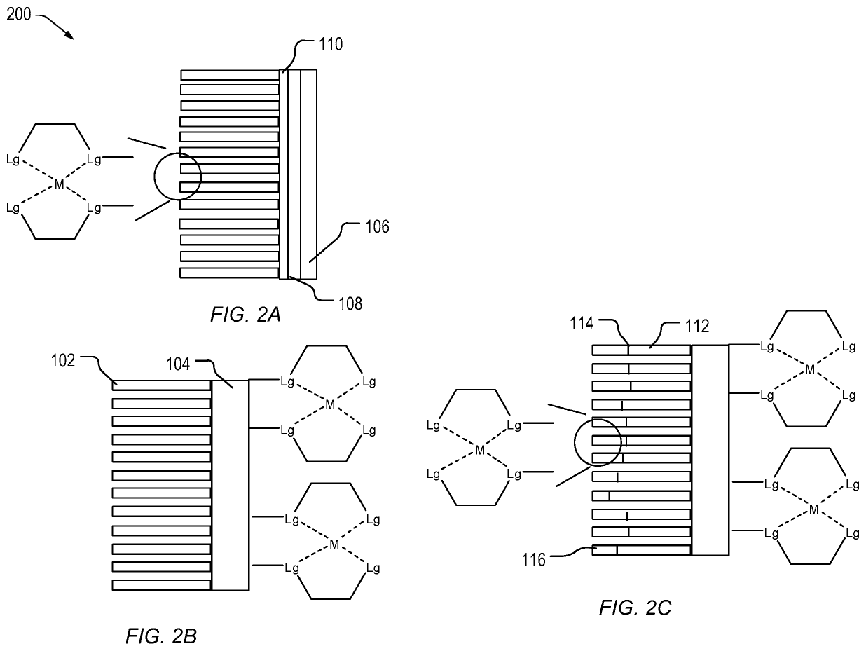

Referring to FIGS. 2A-2C, photocatalyst 200 is depicted with an organic ligand having linking groups (Lg) attached to the surface of the nanostructure (FIG. 2A), to the support (FIG. 2B), and to the nanostructure and the metal support (FIG. 2C). For ease in illustration, an ethylene carbon chain is shown, however, it should be understood that any of the organic ligands of the present invention can be attached to the linker group. Co-catalyst metal (M) can be coordinated with a linking group of ligand as described below. The co-catalyst metal can be a transition metal. Non-limiting examples of transition metals include metals from Columns 8-12. In some instances, the meatal can be iridium (Ir), ruthenium (Ru), rhenium (Rh), cobalt (Co), cadmium (Cd), iron (Fe), pallidum (Pd), silver (Ag), platinum (Pt). In a preferred instance, the metal is Ir. In some embodiments, metal M is not present.

The organic ligand can have at least two linker groups (Lg) and have the structure of:

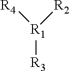

where: R₁ is an aliphatic group, an aromatic group, or a hetero-aromatic group; and R₂, R₃, R₄ are linking groups and are each independently a hydrogen atom, a thiol group, a substituted thiol group, an amino group, a substituted amino group, an hydroxy group, a carbonyl group, a substituted carbonyl group, or a hetero-aromatic group, and at least one or more of R₂, R₃, or R₄ is attached to the surface of the nanostructure or the metal support. R₁ can have 1 to 15, 2 to 10, 3 to 5, or 1, 2, 3, 4, 5, 6, 7, 8, 9, 10, 11, 12, 13, 14, 15 or any range there between of carbon atoms. When R₁ is an aliphatic group, R₄ can be hydrogen, and R₁ can have the formula of (CH₂)ₙ where n is 1 to 15, preferably 2 to 5, more preferably 2 (e.g., disubstituted ethane). R₁, R₂, R₃, and/or R₄ can be an substituted phenyl group (aromatic group), a nitrogen containing aromatic group, an oxygen-containing aromatic group, or a sulfur-containing aromatic group (e.g., thiophene group). In a preferred embodiment, R₁, R₂, and R₄ are nitrogen-containing hetero-aromatic compounds. Non-limiting examples of nitrogen-containing hetero-aromatic compounds include pyridines, pyrroles, or triazines, preferably 1,3,5-triazine. Representative structures of aromatic and hetero-aromatic groups are shown below.

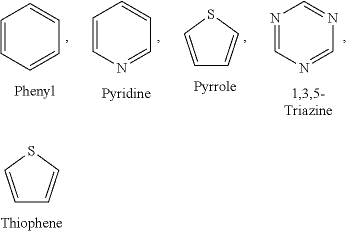

R₂, R₃, and/or R₄ can be a hydrogen (H) atom, a thiol group (—SH), an amino group (—NH₂), a hydroxyl (—OH), a carboxylic acid (—COOH), an ester (—CO₂R₅, where R₅ is aliphatic group, an aromatic group, or a hetero-aromatic group), or an amide (—CONH₂) group. In a preferred embodiment, R₂ and R₃ are thiol groups. Non-limiting examples of ligands with a sulfur linking group are 1,2-ethanedithiol (HSCH₂CH₂SH) and 2,2′:6′,2″-terpyridine-4′-thiol shown below, where a sulfur atom is attached (bonded) to the metal support surface or the nanostructure.

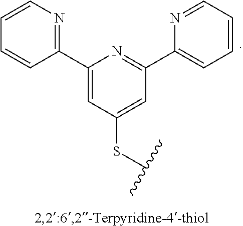 [SMILES: *Sc1cc(-c2ccccn2)nc(-c2ccccn2)c1]

The amount of organic ligand and/or the metal co-catalyst to be used can depend, inter alia, on the catalytic activity of the photocatalyst. In some embodiments, the amount of organic ligand in the photocatalyst can be up to 2 wt. %, or from 0.0001 to 2 wt. % or 0.1 to 1.5 wt. %, or 0.5 to 1 wt. % or any value or range there between, based on the total weight of the photocatalyst. The metal co-catalyst present in the photocatalyst be up to 3 wt. %, or from 0.0001 to 3 wt. % or 0.1 to 2.5 wt. %, 0.5 to 2 wt. %, or 1 wt. % to 1.5 wt. % or any value or range there between, based on the total weight of the photocatalyst.

### C. Preparation of the Photocatalyst

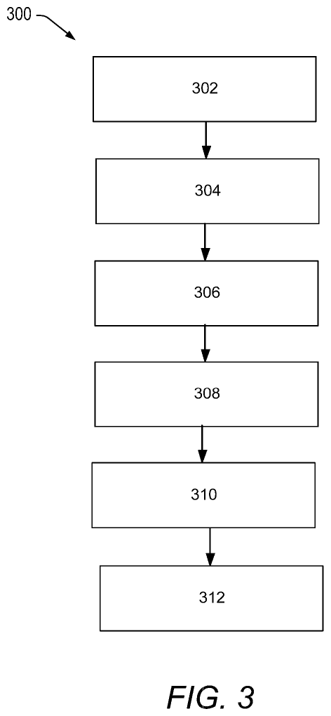

The photocatalyst of the present invention can be made using known techniques for growing nanorods and/or attaching organic ligands to metal substrates. In one embodiment, a catalytic non-oxide semiconductor nanostructure(s) can be grown on a zero valent metal support to form a metal supported catalytic non-oxide semiconductor nanostructure material. The metal supported catalytic non-oxide semiconductor nanostructure material can be contacted with at least one organic ligand that includes at least one linking group under conditions sufficient to attach the ligand to the catalytic non-oxide semiconductor nanostructure and/or the metal support. Referring to FIG. 3, a flow chart of a method to prepare the photocatalyst of the present invention is depicted. In method 300, step 302, zero valent metal support 104 can be obtained (e.g., Mo⁰ substrate). In step 304, optional, second zero valent metal 106 can be deposited on the zero valent metal support 104 using known chemical and physical deposition techniques. Non-limiting examples of deposition techniques include thermal spray coating, vapor deposition, chemical vapor deposition, plasma and thermal spray coating, ion beam techniques (e.g., electron beam evaporator, molecular bean epitaxy, etc.), sputtering and the like. In a preferred embodiment, an electron bean evaporator is used to deposit Ti metal on a Mo metal support. The plasma source can be operated at 345 to 355 W, or about 350 W with a pressure of 1.5 to 2.5×10⁻⁵ torr (about 1.9 to 3.3×10⁻³ Pascal). In step 306, non-oxide semiconductor nanostructures 102 with metal layers and/or dopant layers (e.g., layers 112, 114, and 116) can be grown on the metal support (e.g., either a Mo metal or a Mo—Ti metal support) using known techniques for grown metal nanorods (e.g., a plasma-assisted molecular bean epitaxy technique). By way of example, a first layer that includes n-GaN can be grown at a temperature of 800° C. to 850° C., or about 810° C. to 840° C., or about 815° C. to 830° C. or about 820° C. or any values or ranges there between using a Ga flux of 6.0 to 7.3×10⁻⁶ or 6.6. 10⁻⁶ Pascal (or about 4.5 to 5.5×10⁻⁸ Torr or about 5×10⁻⁸ Torr) or any values or ranges there between. As the first metal nitride layer of the nanostructure is grown a metal nitride interface layer (e.g., TiN) can form on the metal support. Such a metal nitride interface layer can assist in bonding the nanostructure to the metal support. Next, an optional second dopant layer (e.g., n-Al₂₀Ga₈₀N) can be grown at a temperature of 820° C. to 860° C., or about 820° C. to 850° C., or about 825° C. to 840° C. or about 840° C. or any values or ranges there between, using a Ga flux of 4.0 to 5.3×10⁻⁶ or about 4.4×10⁻⁶ Pascal (or about 3 to 4.5×10⁻⁸ Torr or about 3.3×10⁻⁸ Torr) or any values or ranges there between, and an Al flux of 9.3×10⁻⁷ to 1.1×10⁻⁶ or about 1.03×10⁻⁶ Pascal (7.0 to 8×10⁻⁹ Torr or about 7.7×10⁻⁹ Torr) or any values or ranges there between. A third metal layer (In_{0.33}Ga_{0.67}N) can be grown on the top of the dopant layer at a temperature of 590° C. to 620° C., or about 595° C. to 615° C., or about 600° C. to 610° C. or about 607° C. or any values or ranges there between using a Ga flux of 4.0 to 5.3×10⁻⁶ or 4. 10⁻⁶ Pascal (or about 3 to 4.5×10⁻⁸ Torr or about 3.×10⁻⁸ Torr) or any values or ranges there between, and an indium flux of 6×10⁻⁶ to 7.3×10⁻⁶, or about 6.6×10⁻⁶ Pascal (4.5 to 5.5 10⁻⁸ or about 5×10⁻⁸ Torr) or any values or ranges there between to form photocatalyst 100.

In step 308, the photocatalyst 100 can be contacted with a solution that includes the organic ligand to functionalize (e.g., passivate) the surface of the nanostructures 102 and/or the metal support 104. In some embodiments, oxides formed during the nanostructure growth can be removed by contacting the surface of the nanostructures with a buffered oxide etch solution, followed by an alcohol cleaning (e.g., ethanol) prior to contacting the photocatalyst 100 with the organic ligand solution. Non-limiting examples of buffered oxide etch (BOE) include mixtures of a buffering agent such as ammonium fluoride (NH₄F), and hydrofluoric acid (HF). The nanostructures can be contacted with the buffering agent for a short time (e.g., 2 minutes) to remove the native oxides before addition of the organic ligand passivation. Use of a buffered oxide etch avoids undesirable etching of the metal substrate.

The photocatalyst 100 can be contacted (e.g., dipped or immersed) in the organic ligand solution at 20 to 35° C., or about 25° C. to 30° C. for a desired period of time (e.g., 0.1 hour to 24 hour, or 0.5 to 10 hour, or 0.5 to 1 hour). The organic ligand solution can be a neat solution (e.g., 100 vol. % organic solution) or a mixture of organic ligand and solvent (e.g., methanol, ethanol, propanol, acetonitrile etc.). The volume of organic ligand in the solvent can range from 0.5 vol. % to 99 vol. %, from 1 vol. % to 50 vol. %, 10 vol. % to 40 vol. % or about 5 vol. %, or any value or range there between. In instances where only nanostructures 102 or portions of nanostructures are functionalized, the metal support 104 does not have to be contacted with the organic ligand solution and vis versa when only the support 104 or portions of the support are functionalized. When both nanostructures 102 and metal support 104 are functionalized, the entire photocatalyst 100 can be immersed in the organic ligand solution. In step 310, the surface functionalized nanostructure can be contacted with a co-catalyst metal precursor solution to complex the metal co-catalyst with a linker group (e.g., sulfur atom) of the functionalized surface at 20 to 35° C., or about 25° C. to 30° C. for a desired period of time (e.g., 0.5 hour to 24 hour, or 0.5 to 10 hour, or 0.5 to 1 hour). The co-catalyst metal precursor solution can be metal halide, metal nitrate, metal hydroxide dissolved in a solvent such as aqueous alcohol or aqueous acetonitrile solution (e.g., 1:1 to 10:1, 2:1, to 8:1, or 3:1 to 6:1, or about 5:1 organic solvent to water). The solvent can include at least 1×10⁻⁶ to 10×10⁻⁶, 1×10⁻⁶ to 5×10⁻⁶ x or about 3×10⁻⁶ moles of co-catalyst metal precursor. The volume of the co-catalyst metal precursor in the solvent can be 0.1 to 10 vol. %, 1 to 8 vol. %, or about 5 vol. %, or any value or range there between. By way of example, Ir co-catalysts can be attached to the sulfur linking groups of the organic ligand by immersing the functionalized photocatalyst for 30 min in 1 mg/mL IrCl₃ dissolved in 5:1 CH₃CN:H₂O by volume. In step 312, the metal co-catalyst/surface functionalized non-oxide metal semiconductor photocatalyst on a metal support can be dried under at flow of nitrogen at 20 to 30° C. or about ambient temperature.

### D. Systems and Method of Use

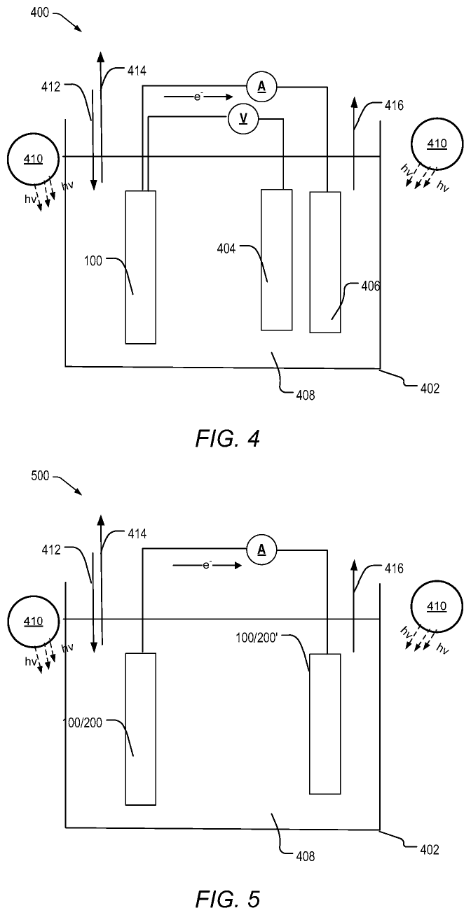

The photocatalyst of the present invention can be used to produce H₂ and O₂ from water. The photocatalyst can be subjected to a light source (e.g., solar source such as sunlight or an artificial light source) for a sufficient period of time to produce H₂ and O₂. In some embodiments, the photocatalyst can be used as an anode (n-type photocatalyst) or a cathode (p-type photocatalyst) in a photoelectrochemical system. FIG. 4 depicts system 400 for photoelectrochemical water-splitting. In system 400, container 402 can include photocatalyst 100 or photocatalyst 200 (photocatalyst 100 is shown) of the present invention as the working electrode (n-type electrode), reference electrode 404, counter electrode 406, aqueous electrolyte solution 408 and solar source 410. Reference electrode 404 can be any suitable reference electrode for photoelectrochemical applications. By way of example, reference electrode 404 can be an Ag/AgCl electrode. Counter electrode 406 can be any counter electrode suitable reference electrode for photoelectrochemical applications. By way of example, counter electrode 406 can be a Ni-mesh decorated with sputtered Pt-nanoparticles.

The electrolyte solution can be any suitable buffered water solution such as a 0.1 M potassium phosphate buffer solution (pH˜7). Solar source 410 can be sunlight or a solar simulator. In system 400, water stream 412 can enter electrolyte solution 408 in container 402. Photocatalyst 100 can be irradiated by solar source 410. Upon excitation by solar source 410, the photocatalyst 100 can catalyze the splitting of water to generate electron-hole pairs. As shown in FIG. 4, photocatalyst 100 is an n-type semiconductor electrode so the holes react with water molecules at the semiconductor nanostructure surface resulting into O₂ containing stream 414 and electrons (e) travel through substrate and are transported to the counter electrode where they reduce H⁺ into H₂ containing stream 416. Hydrogen containing stream 416 and oxygen containing stream 414 can be collected or transported to other units for processing or use as a feedstock. The streams can also be sold as products.

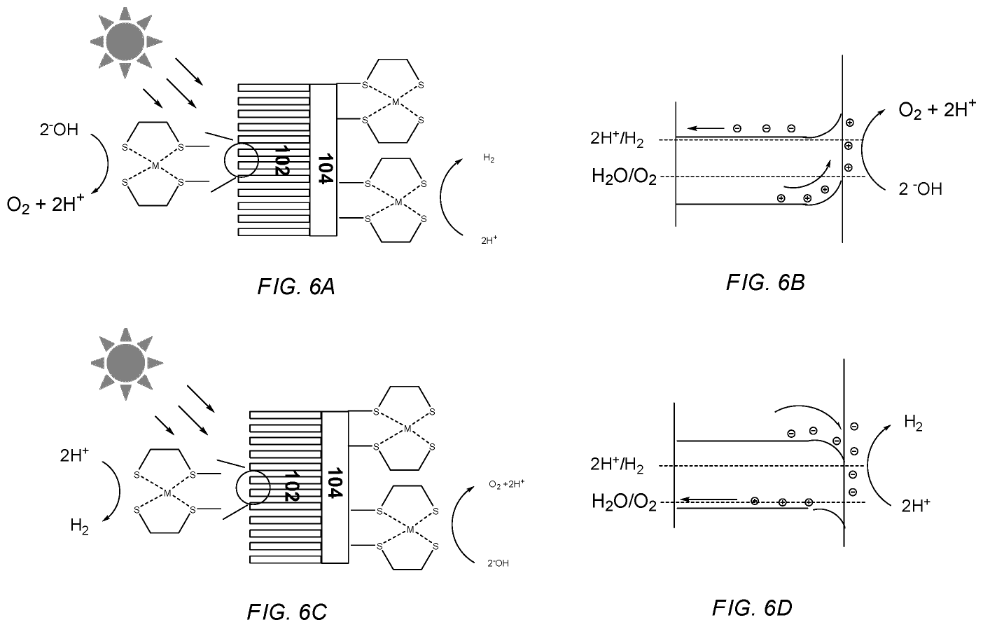

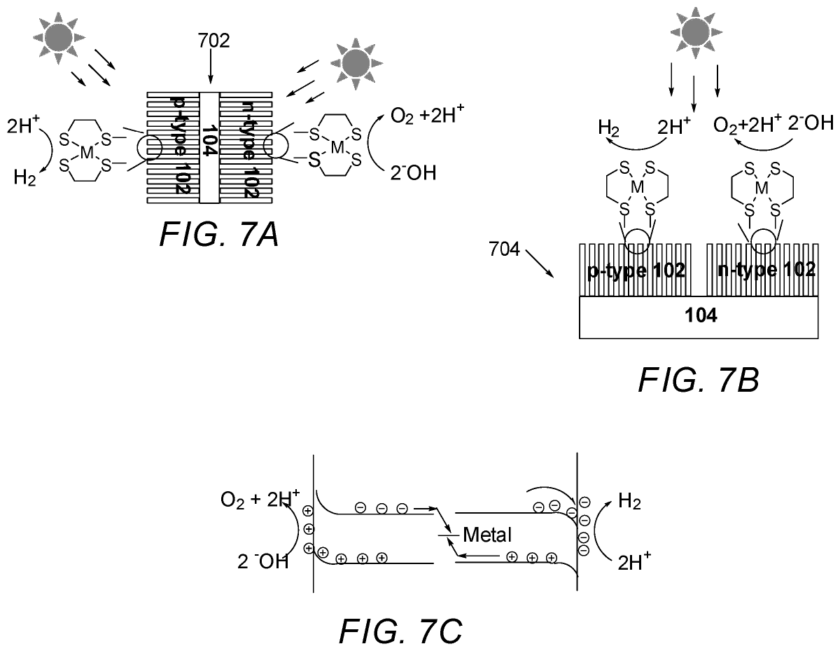

FIG. 5 depicts a system where the photocatalyst is used as a n and p-type photocatalyst. In FIG. 5, system 500 includes working electrode 100/200 and counter electrode 100/200′. Upon excitation by solar source 410, the photocatalyst 100/200 can catalyze the splitting of water to generate electron-hole pairs so that the holes react with water molecules at the semiconductor nanostructure surface resulting into O₂ containing stream 414. Generated electrons (e) travel through substrate and are transported to the counter electrode where, upon excitation by solar source 410, they reduce H⁺ into H₂ containing stream 416. FIGS. 6A-D are schematics of the n-type photocatalyst water-splitting process (FIG. 6A) and electron-hole equilibrium diagram (FIG. 6B) and the p-type photocatalyst water-splitting process (FIG. 6C) and electron-hole equilibrium diagram (FIG. 6D). Hydrogen containing stream 416 and oxygen containing stream 414 can be collected or transported to other units for processing or use as a feed stock. The streams can also be sold as product.

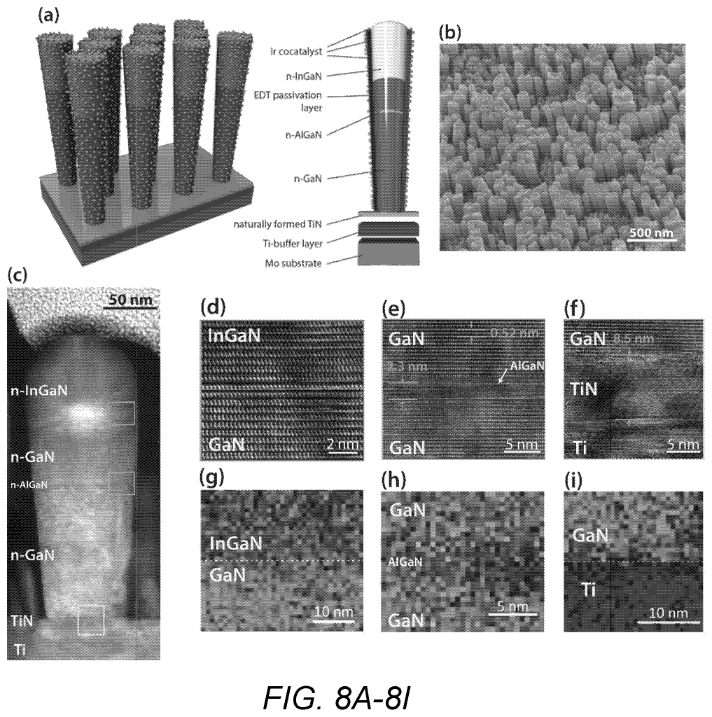

Referring to FIGS. 7A-7C, Z-scheme type systems using the photocatalysts of the present invention and electron-hole equilibrium diagrams are depicted. In FIG. 7A, photocatalyst catalyst 700 includes nanostructures 102 on both sides of metal substrate 104 and both sides of the photocatalyst are illuminated. In FIG. 7B, photocatalyst 702 include nanostructures 102 on both sides of metal substrate 104, with no surface modification of the metal surface. Nanostructures 102 can function as p- and n-type photocatalyst. FIG. 7C is an electron-hole equilibrium diagram for production of hydrogen and oxygen from water (total water-splitting).

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Example 1

### Synthesis of In₄₅Ga₅₅N-Based Nanorod Photocatalyst of the Present Invention

In_{0.33}Ga_{0.67}N-based nanorods (NRs) photocatalysts were grown by Veeco Gen930 plasma-assisted MBE system (Veeco, U.SA.) on a molybdenum metal support (1 cm²). Prior to growth, 500 nm Ti was deposited on the Mo support (Goodfellow, USA) using an electron beam evaporator. The plasma source was operated at 350 W with a pressure of 2.3×10⁻⁵ Torr. The n-GaN, n-Al₂₀Ga₈₀N, and n-In_{0.33}Ga_{0.67}N layers were grown at thermocouple temperatures of 820° C., 840° C., and 607° C., respectively. The Ga fluxes in GaN, Al₂₀Ga₈₀N and In_{0.33}Ga_{0.67}N were 5×10⁻⁸ Torr, 3.3×10⁻⁸ Torr, and 3×10⁻⁸ Torr, respectively. The Al and In fluxes were 7.7×10⁻⁹ Torr and 1.5×10⁻⁸ Torr, respectively.

### Example 2

### Surface Functionalization and Co-Catalyst Metal Addition to In₄₅Ga₅₅N-Based Nanorod Photocatalyst of the Present Invention

The surface states of the In_{0.33}Ga_{0.67}N-based NRs were functionalized using a short-carbon chain 1,2-ethanedithiol (C₂H₄(SH)₂) EDT compound. Prior to the EDT functionalization, the native oxides were removed at room temperature by buffered oxide etch (BOE) for two minutes followed by ethanol cleaning and the etched nanostructures were dipped in the EDT solution for 30 minutes. The Ir co-catalysts were attached to the sulfur atoms by immersing the functionalized samples for another 30 min in 1 mg/mol IrCl₃ dissolved in 5:1 CH₃CN:H₂O. The fabricated samples were then dried by nitrogen and prepared for the different characterization and PEC experiments.

### Example 3

### Characterization of In₄₅Ga₅₅N-Based Nanorod Photocatalyst of Examples 1 and 2

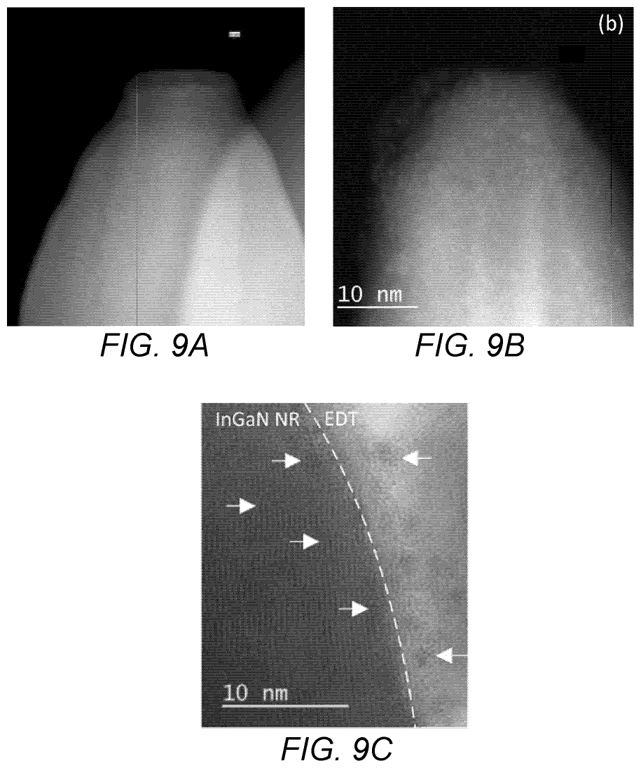

In₄₅Ga₅₅N-based Nanorods. The morphology of the In_{0.33}Ga_{0.67}N-based NRs was characterized using Quanta 3D FEG field emission SEM (FEI/Thermo Fischer Scientific, U.S.A) working at 5 kV. To study the interface quality between the successive layers of the NRs and between them and the metal substrate, a cross-sectional TEM sample was prepared using a lift-out technique in an FEI Helios NanoLab 400s Dual Beam focused ion beam (FIB)/SEM equipped with an Omni probe (FEI/Thermo Fischer Scientific, U.S.A). The TEM characterizations were performed using an FEI Titan 80-300 kV (ST) with a field-emission gun operating at 300 kV. EDS analysis was performed using an EDS Genesis apparatus coupled to the FEI Quanta 600FEG SEM ((FEI/Thermo Fischer Scientific, U.S.A) using the following parameters: acceleration voltage=30 kV, beam spot=5.0, duty cycle=22%, CPS>20000, amplifier time=3.2 μs, 250× magnification, and mapping area of 1200 μm². FIGS. 8A-8I show the morphology and microstructure of the In_{0.33}Ga_{0.67}N-based nanorods of the present invention supported on the Mo substrate. FIG. 8A is a schematic illustration showing the entire structure of the NRs including the successive layers and the metal-stack substrate. The thickness of the EDT passivation layer and the size of Ir co-catalysts are only for clarification and do not represent the actual thickness or size. FIG. 8B is 40°-tilted SEM image of the as-grown NRs. FIG. 8C is a cross-sectional TEM image of a single representative In_{0.33}Ga_{0.67}N-based NR on the zero valent metal/metal-nitride-stack substrate. FIGS. 8D-F are high resolution TEM images collected at the different layer interfaces. FIGS. 8G-I are corresponding EDS mappings for the interfaces shown in FIGS. 8D-F.

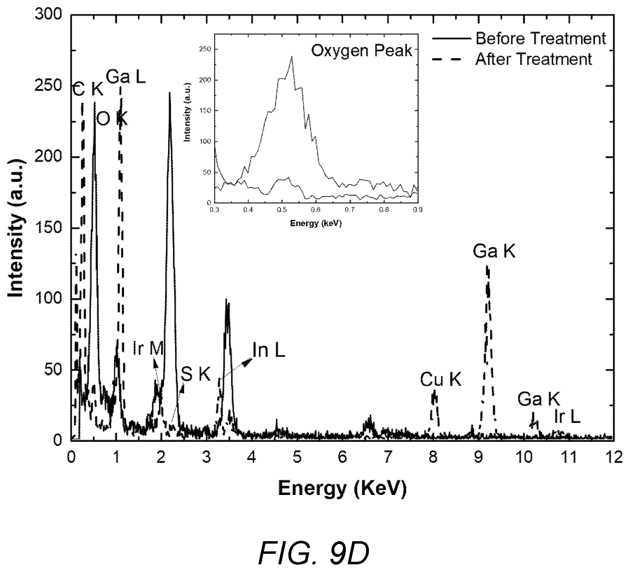

Functionalized and Co-Catalyst-In₄₅Ga₅₅N-based Nanorods. The surface features after EDT/Ir treated In₄₅Ga₅₅N-based nanorods of the present invention were characterized using TEM (Titan 80-300 ST, FEI Company). The microscope was equipped with a spherical aberration corrector from CEOS to perform the aberration-corrected STEM and also an energy-filter of model GIF Quantum 966 from Gatan, Inc. (Pleasanton, Calif.) to perform EELS mapping. The microscope was utilized by setting the accelerating voltage to 300 kV and to STEM mode during the analysis of samples. STEM images were recorded by collecting the transmitted electrons from ˜70 mrad to 200 mrad with a high-angle annular dark-field detector in order to make the atomic-number (Z) contrast dominant in them. EELS parameters were set during the elemental mapping in such a way that enabled to acquire the C-K edge (284 eV), N-K edge (401 eV), In-M45 edge (443 eV), and Ga-L23 edge (115 eV) for C, N, In, and Ga elements, respectively. The presence of S and Ir elements was confirmed with EDS, since it showed a low signal to noise ratio in EELS spectrum in the lower energy-loss range (below 100 eV). FIGS. 9A-D depicts atomic-scale surface features before and after EDT/Ir treatment. FIG. 9A depicts high-angle annular dark field STEM image of the as-grown In_{0.33}Ga_{0.67}N-based NRs. FIG. 9B depicts high-angle annular dark field STEM image of the EDT/Ir-treated In_{0.33}Ga_{0.67}N-based NRs. FIG. 9C depicts high resolution bright field STEM showing the EDT layer and the dispersion of Ir co-catalyst in the surface of the treated NRs. FIG. 9D depicts EDS analysis measured at high resolution for the as-grown (top line in inset) and the EDT/Ir-treated sample (bottom line in inset) under similar acquisition parameters.

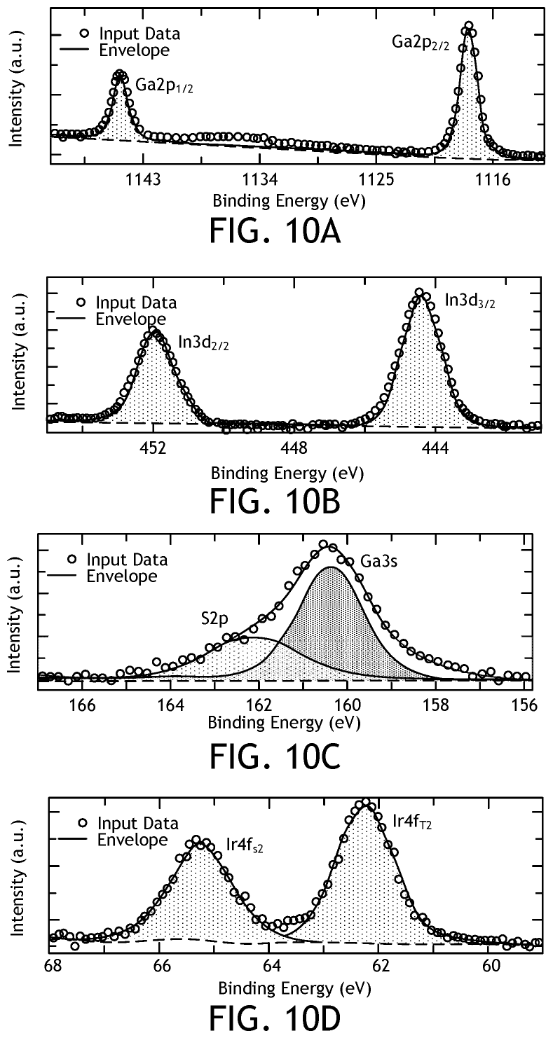

XPS characterization. The XPS data were obtained with an Axis Ultra DLD system (Kratos, U.K.) using an Al Kα radiation source (hv=1486.8 eV). The binding energy was calibrated with respect to the adventitious 284.8 eV C1s peak. The data analysis was performed with CasaXPS. FIGS. 10A-D depict XPS Ga2p, In3d, Ga3s, S2p, and Ir4f of the surface components of the In_{0.33}Ga_{0.67}N-based NRs treated with EDT and Ir co-catalyst. FIG. 10A depicts XPS Ga2p showing the Ga³⁺ related peaks. FIG. 10B depicts XPS In3d showing the In³⁺ related peaks. FIG. 10C depicts XPS S2p/Ga3s showing the Ga3s contribution of GaN and the S2p of EDT. FIG. 10D depicts Ir4f region showing the presence of Ir³⁺ on the top of In_{0.33}Ga_{0.67}N-based NRs surface.

### Example 4

### Production of Hydrogen and Oxygen Using the Photocatalyst of Example 2

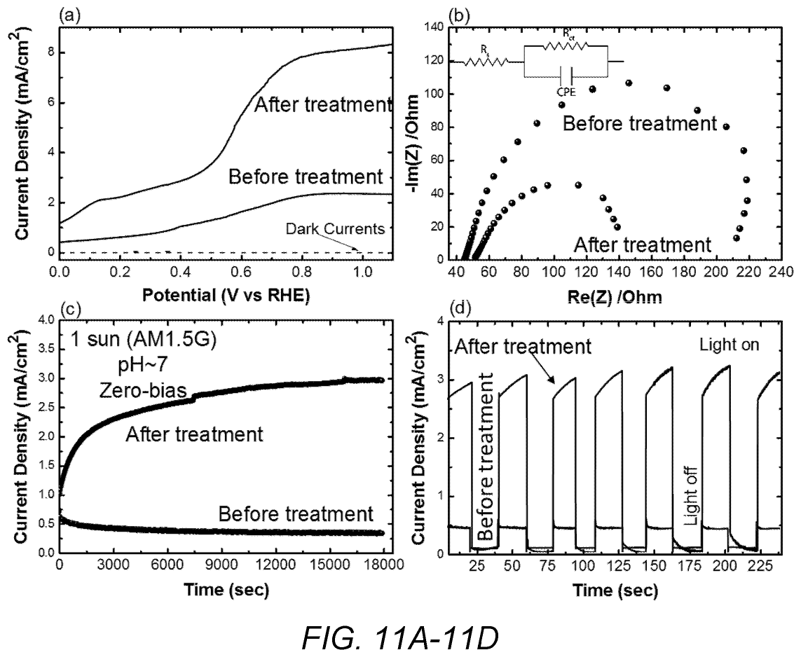

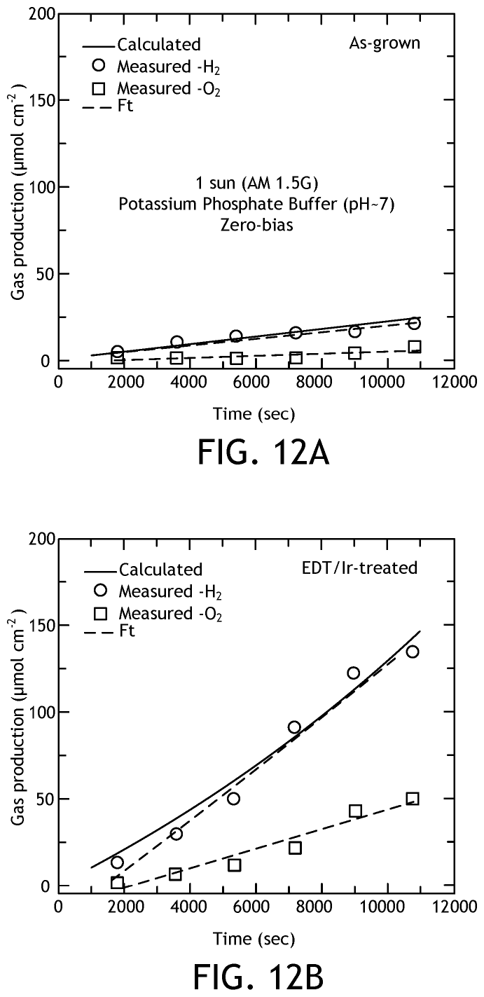

Photoelectrochemical (PEC) measurements of EDT/Ir/In_{0.33}Ga_{0.67}N-based NR photoanodes of Example 2. PEC experiments were conducted in a three-electrode configuration cell using EDT/Ir/In_{0.33}Ga_{0.67}N-based NRs as the working electrode, a Ni-mesh decorated with sputtered Pt-nanoparticles as counter electrode, and Ag/AgCl as the reference electrode. The conversion from Ag/AgCl to RHE was calculated using the Equation: E(RHE)=E⁰_{(Ag/AgCl)}+E_{(Ag/AgCl)}+0.059×pH, where E(RHE) is the potential relative to the RHE, E⁰_{(Ag/AgCl)} is the standard potential of the Ag/AgCl electrode equal to 0.197 V, E_{(Ag/AgCl)} is the applied potential versus the Ag/AgCl reference electrode. A potassium phosphate buffer solution (0.1 M, pH about 7) was used as the electrolyte. The photoanodes were irradiated with simulated sunlight produced by an AM1.5G filter using the solar simulator HAL-320 (Asahi Spectra, U.S.A). The light irradiance was kept constant during the measurements at 1 sun (100 mWcm⁻²). The linear scan voltammetry and chronoamperometry experiments were performed using a single channel Biologic-VSP potentiostat controlled by EC-Lab® (Bio-Logic Science Instruments, France) software. The reactor was made of quartz with good transmittance for both UV and visible light. The entire sample except for the NR surface was covered by insulating epoxy to eliminate any current leakage and exclude any contribution from the Mo—Ti substrate. A highly conductive Cu wire was bonded to the sample using silver paste. A Ga/In eutectic alloy (Sigma-Aldrich®, U.S.A.) was deposited on the Mo substrate backside to make good Ohmic contact. The gas evolution rates were measured in a vacuum-tight quartz reactor using an Agilent 7890B gas chromatograph system (Agilent, U.S.A.) equipped with a thermal conductivity detector. Table 1 lists applied bias photon-to-current conversion efficiency (ABPE), gas evolution rate, and STH efficiency. ABPE measured for photocatalysts of Examples 1 and 2. Rate of hydrogen evolution and corresponding STH efficiency values are also shown for the same samples. FIGS. 11A-11D show the PEC performance of In_{0.33}Ga_{0.67}N-based NRs and EDT/Ir functionalized In_{0.33}Ga_{0.67}N-based NRs of the present invention. FIG. 11A depicts a linear scan voltammetry of the EDT/Ir-treated sample (top curve) compared to the as-grown one (bottom curve), measured under 1 sun (AM1.5G) illumination in pH=7 buffer electrolyte. Dotted-lines represent the dark currents. FIG. 11B are Nyquist plots showing the interfacial resistance behaviors between the EDT/Ir-treated sample (top curve), the as-grown one (bottom curve) and the electrolyte. FIG. 11C is a chronoamperometry test showing the long-term stability of the current against time at zero bias and under 1 sun (AM1.5G) illumination of the EDT/Ir-treated sample (top curve), the as-grown one (bottom curve). The inset displays the current density stabilization after three hours. FIG. 11D is a chronoamperometry test under chopped light illumination emphasizes the high photoactivity of the photoanodes after PEC experiment of EDT/Ir-treated sample (top curve), the as-grown one (bottom curve). Notably, when the light is turned off there is no current produced (see, time at 178 minutes). FIGS. 12A and 12B show hydrogen and oxygen evolution measured at zero bias and under 1 sun (AM1.5G). FIG. 12A shows the as-grown sample. FIG. 12B shows after EDT/Ir functionalization. The top graphs are measured H₂, the bottom graphs are O₂, and the dotted lines are the straight-line fitting used to calculate the gas evolution rate. The gas evolution was normalized to the surface area of each sample. The bottom lines represent the calculated gas amount. From the data, it was determined that 3.5% STH on a n-type In₄₅Ga₅₅N under 1 Sun illumination at pH=7 was achieved by integrating small bandgap (1.65 eV) InGaN-based NRs on a molybdenum (Mo) substrate, passivating the surface with 1,2 ethanedithiol (EDT), and anchoring Ir on the surface through EDT. The water-splitting process was repeated and the system continuously produced H₂ and O₂ for more than 12 hours.

TABLE 1

| | | R(H₂) | |
|---|---|---|---|
| | ABPE | μmol cm⁻² sec⁻¹ | STH |
| Sample | (%) | (zero bias/1 sun) | (%) |
| As-grown | 1.0 (0.76 V vs RHE) | 0.17 × 10⁻² | 0.4 |
| EDT/Ir-treated | 3.7 (0.79 V vs RHE) | 1.47 × 10⁻² | 3.5 |

### Example 5

### Characterization of the Photocatalyst of Example 2 After Use

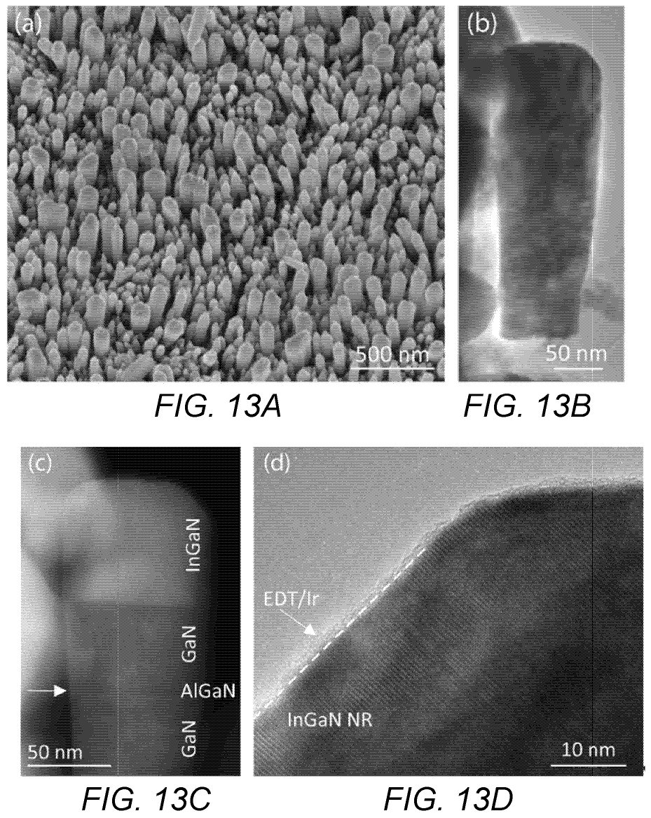

The morphology and microstructure of the photocatalyst of the present invention from Example 2 was examined after the water-splitting reaction. FIGS. 13A-D depict morphology and microstructure of In_{0.33}Ga_{0.67}N-based NRs after PEC water-splitting experiment. FIG. 13A is a 40°-tilted SEM image of the EDT/Ir-treated In_{0.33}Ga_{0.67}N-based

NRs sample after 8 hours of irradiation. FIG. 13B is a bright field STEM image of one representative NR. FIG. 13C is a dark field STEM image showing the detailed structure of In_{0.33}Ga_{0.67}N-based NR. FIG. 13D is a high resolution STEM image showing the atomic-scale features of the NR surface after PEC experiment. The stability of the EDT/Ir-treated sample was further confirmed by SEM and high resolution STEM (FIGS. 13A-D) after chronoamperometry and gas evolution experiments (more than 8 hours). No significant damage was observed in the EDT/Ir/In_{0.33}Ga_{0.67}N-based NRs (FIG. 13B). As displayed by the STEM images shown in FIGS. 13C and 13D, respectively, the NRs maintained the same structure after PEC water oxidation experiment (compared with FIG. 8C) and covered uniformly with ultrathin EDT/Ir layer. The morphological analysis obtained here reflects the superior chemical stability of EDT/Ir-treated In_{0.33}Ga_{0.67}N-based NRs, which can be partially attributed to the passivated surface states.

### Example 6

### Determination of Turnover Number and Frequency

The turnover number (TON) is defined as the ratio of the total gas evolved to the amount of the catalyst. The average length of the NRs was approximately 270 nm, the bottom radius was 38.5 nm, and the top radius was 51 nm. The volume of one representative NR was calculated from the equation:

V_{NR}=⅓π(r₁²+r₁r₂+r₂²)h

where r₁ and r₂ were the radius of the top and bottom parts of the NR, respectively, and his the NR height, which gave the V_{NR} to be 1.7×10⁻¹⁵ cm³. Given that the atomic density (number of atoms in one cm³) for GaN was 8.9×10²² cm³, then the number of atoms in one NR was estimated by multiplying this number by V_{NR} that gives 1.5×10⁸ atoms. From the XPS results, the atomic % of Ir co-catalyst was found to be about 0.93%, then the number of Ir atoms attached to one NR was approximately 1.4×10⁶ atoms. The amount of Ir co-catalyst attached to the surface of one NR in moles as calculated by dividing the last number by Avogadro's number (6.02×10²³ mol⁻¹), which gave 2.3×10⁻¹⁶ mol. Knowing that the area of the exposed surface during the experiment was 0.66 cm² (for EDT/Ir-treated sample) and the surface density of NRs was 8.7×10⁷ cm⁻², the total amount of Ir co-catalysts used during the gas evolution experiment was calculated. The total amount of Ir co-catalysts was estimated to be approximately 1.3×10⁻² μmol.

The TON of water oxidation using Ir co-catalysts attached to InGaN NRs can be then calculated as:

$$T O N = \frac{amount of oxygen gas evo1ved}{amount of Ir co \text{-} catalysts}$$

The amount of evolved oxygen gas after three hours of irradiation was 31.5 μmol. Thus, the TON for water oxidation is approximately 2423.

The turnover frequency (TOF) can be defined as the turnover per unit time, which is given by:

$$T O F = \frac{T O N}{irradiation time}$$

For three hours of irradiation time, the TOF was estimated to be approximately 0.23 s⁻¹.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein can be utilized. Accordingly, the appended claims are intended to include within their scope such processes, machines, manufacture, compositions of matter, means, methods, or steps.

1. A supported photocatalyst comprising:
(a) a support comprising a metal having a zero valence (M⁰);
(b) a catalytic non-oxide metal semiconductor nanostructure attached to the support, wherein the catalytic non-oxide metal semiconductor nanostructure comprises a metal surface; and
(c) an organic ligand comprising two or more linking groups, wherein at least one of two linking groups is covalently bound to the surface of the catalytic non-oxide metal semiconductor nanostructure, and at least one of the two linking groups is complexed with a transition metal;
wherein the metal support comprises Mo⁰ and the non-oxide metal semiconductor nanostructure comprises an InGaN nanostructure having the formula of InₓGa₁₋ₓN, where 0.0≤x≤1.

2. The supported photocatalyst of claim 1, wherein M⁰ comprises at least one of molybdenum metal (Mo⁰), titanium metal (Ti⁰), tungsten metal (W⁰), tin metal (Sn⁰), alloys, or layers thereof.

3. The supported photocatalyst of claim 2, wherein M⁰ is a Mo⁰—Ti⁰ stack.

4. The supported photocatalyst of claim 1, further comprising a titanium nitride layer positioned between the metal support and the catalytic non-oxide semiconductor.

5. The supported photocatalyst of claim 2, further comprising a titanium nitride layer positioned between the metal support and the catalytic non-oxide semiconductor.

6. The supported photocatalyst of claim 5, wherein 0.04≤x≤0.50.

7. (canceled)

8. The supported photocatalyst of claim 1, further comprising a second organic ligand-comprising two or more linking groups attached to the metal support.

9. The supported photocatalyst of claim 1, wherein the organic ligand has the general structure of: 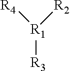
where:
R₁ is an aliphatic group, an aromatic group, or a hetero-aromatic group; and
R₂, R₃, R₄ are linking groups and are each independently a hydrogen atom, a thiol group, a substituted thiol group, an amino group, a substituted amino group, an hydroxy group, a carbonyl group, a substituted carbonyl group, or a hetero-aromatic group, and at least one or more of R₂, R₃, or R₄ is attached to the surface of the nanostructure or the metal support.

10. The supported photocatalyst of claim 9, wherein R₁ is an aliphatic group, R₂ and R₃ are sulfur atoms, and R₄ is a hydrogen atom and R₂ and/or R₃ are attached to the surface of the nanostructure or the metal support.

11. The supported photocatalyst of claim 9, wherein the organic ligand has a formula of —SCH₂CH₂S—, and at least one of the sulfur atoms is attached to the surface of the nanostructure or the metal support.

12. The supported photocatalyst of claim 11, wherein R₁ is a hetero-aromatic group, and R₃ is a sulfur atom, and R₂ and R₄ are each independently a hetero-aromatic group and R₃ is attached to the surface of the nanostructure or the metal support.

13. The supported photocatalyst of claim 12, wherein the organic ligand has the formula of: 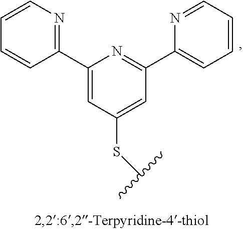 [SMILES: *Sc1cc(-c2ccccn2)nc(-c2ccccn2)c1]
and the sulfur atom is attached to the surface of the nanostructure or the metal support.

14. The supported photocatalyst of claim 8, wherein at least one of the two linking groups is complexed with a transition metal.

15. The supported photocatalyst of claim 1, wherein the transition metal is selected from the group consisting of iridium (Ir), ruthenium (Ru), rhenium (Rh), cobalt (Co), cadmium (Cd), iron (Fe), pallidum (Pd), silver (Ag) and platinum (Pt).

16. The supported photocatalyst of claim 1, wherein the catalyst is a monolithic integrated p-type semiconductor.

17. The supported photocatalyst of claim 1, wherein the catalyst is a Z-scheme catalyst.

18. A process for making the supported photocatalyst of claim 1, the process comprising:
(a) growing a catalytic non-oxide semiconductor nanostructure on a zero valent metal support to form a metal supported catalytic non-oxide semiconductor nanostructure material; and
(b) contacting the metal supported catalytic non-oxide semiconductor nanostructure material with at least one organic ligand comprising at least one linking group under conditions sufficient to attach the ligand to the catalytic non-oxide semiconductor nanostructure.

19. A method for producing hydrogen (H₂) from water, the method comprising:
(a) obtaining a composition comprising water and any one of the photocatalysts of claim 1; and
(b) subjecting the composition to a light source, for a sufficient period of time to produce H₂ from the water.

20. (canceled)

21. A supported photocatalyst comprising:
(a) a support comprising a metal having a zero valence (M⁰);
(b) a catalytic non-oxide metal semiconductor nanostructure comprising InGaN attached to the support, wherein the catalytic non-oxide metal semiconductor nanostructure comprises a metal surface;
(c) a titanium nitride layer positioned between the metal support and the catalytic non-oxide semiconductor;
(d) an organic ligand comprising two or more linking groups, wherein at least one of two linking groups is covalently bound to the catalytic non-oxide metal semiconductor, and at least one of the two linking groups is complexed with a transition metal; and
(e) a second organic ligand-comprising two or more linking groups attached to the metal support.
